(19) United States
(12) Patent Application Publication
(10) Pub. No.: US 2011/0171616 A1
(43) Pub. Date: Jul. 14, 2011

(54) Method for Loss Prevention by Means of an Online Training Center

(76) Inventor: Taydama Saykon JACKSON, Douglasville, GA (US)

(21) Appl. No.: 12/903,670

(22) Filed: Oct. 13, 2010

Related U.S. Application Data
(60) Provisional application No. 61/294,268, filed on Jan. 12, 2010.

(51) Int. Cl. G09B 19/06

(52) U.S. Cl. 434/157

(57) ABSTRACT

An online training center that users are able to log onto to receive supplemental lessons for learning English. The present invention also provides students with different methods of practicing the English that they learned. The present invention aims to spread the English language to promote more understanding between people of different culture. With better understanding between people, there is less conflict and more peace.

The current application claims a priority to the U.S. Provisional Patent application Ser. No. 61/294,268 filed on Jan. 12, 2010.

### FIELD OF THE INVENTION

The present invention relates generally to an online training center for the prevention of loss. More specifically, the present invention is a method for teaching English to anyone as well as training them to become TESOL teachers to reduce terrorist attacks and increase public safety.

### BACKGROUND OF THE INVENTION

Disagreements and arguments generally originate from misunderstandings between two parties. If two parties are able to understand one another, arguments and disagreements can often be avoided. A common source of misunderstanding between people is a language barrier. With a language barrier, two parties are unable to properly convey their thoughts to each other and frustration can easily be escalated. In the United States, there have been averages of about 1 million people who immigrate to the US and obtaining permanent resident status annually. Many of those who come have very limited English and have trouble adapting to the culture, laws and language. As a result of inability to adapt, frustrations and problems arise. To release frustration, some people become violent and safety becomes a major issue. Problems such as traffic safety can also be an issue as immigrants who do not fully understand US traffic laws can drive while unknowingly breaking traffic laws. The present invention aims to overcome this problem by introducing a new method and system that will allow anyone to learn English for a safer and more fruitful community.

### BRIEF DESCRIPTION OF THE DRAWINGS

FIG. 1 shows the linked relationship between all of the pages included on the online training center of the present invention.

FIG. 2 shows the interface that students can use to manage their documents on the document management interface.

FIG. 3 shows the interface that teachers can use to retrieve completed assignment from students after submission.

FIG. 4 shows a relationship diagram of the curriculum database, document database, and story database.

FIG. 5 shows a relationship diagram of the results associated with learning English and understanding English.

FIG. 6 shows a relationship diagram of the results associated with learning to teach English.

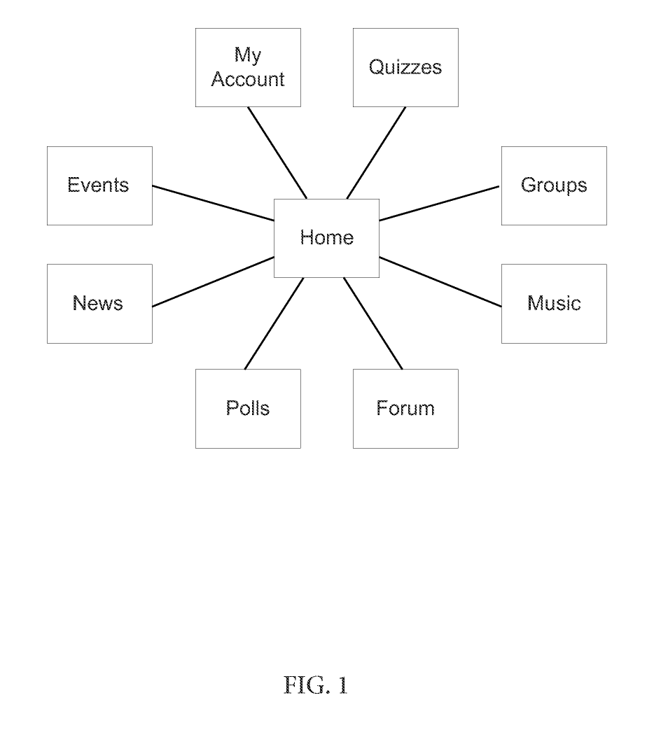

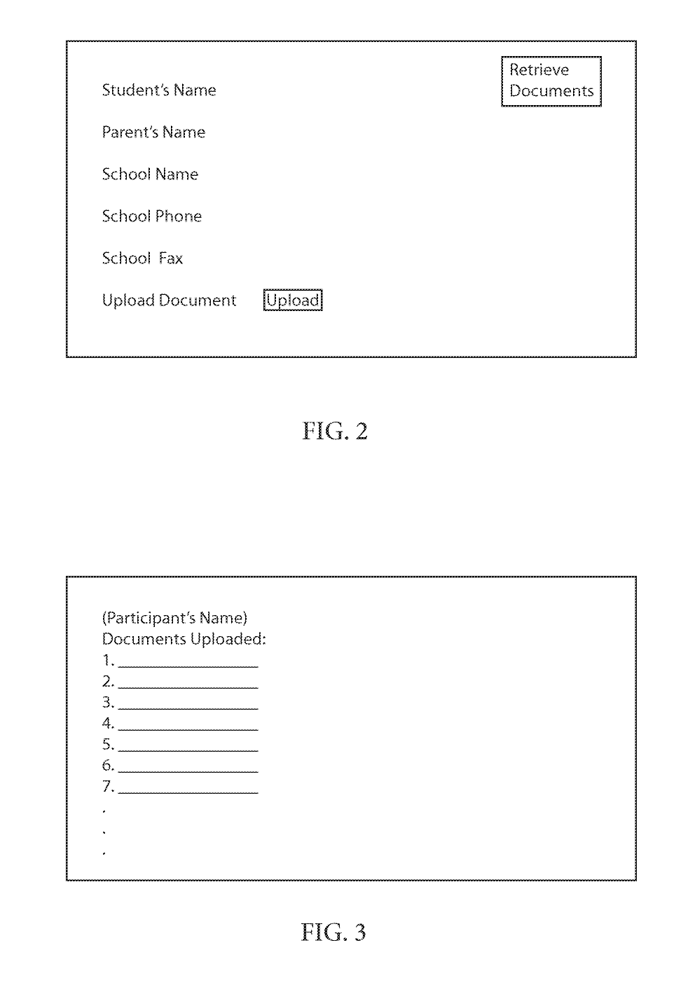

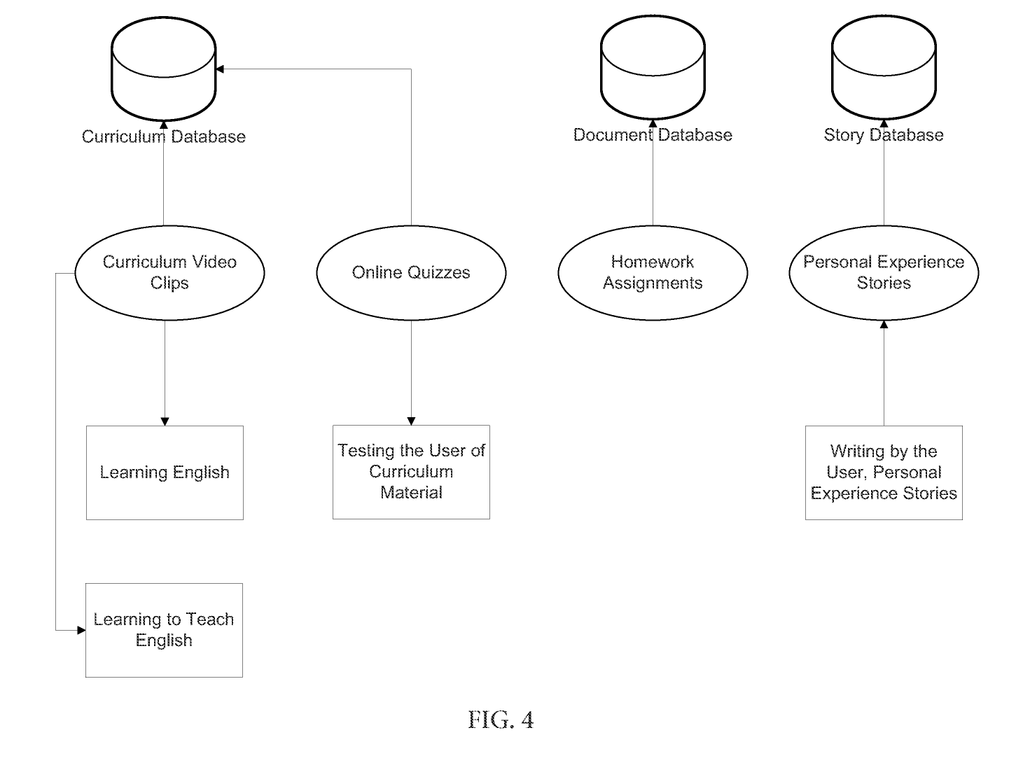

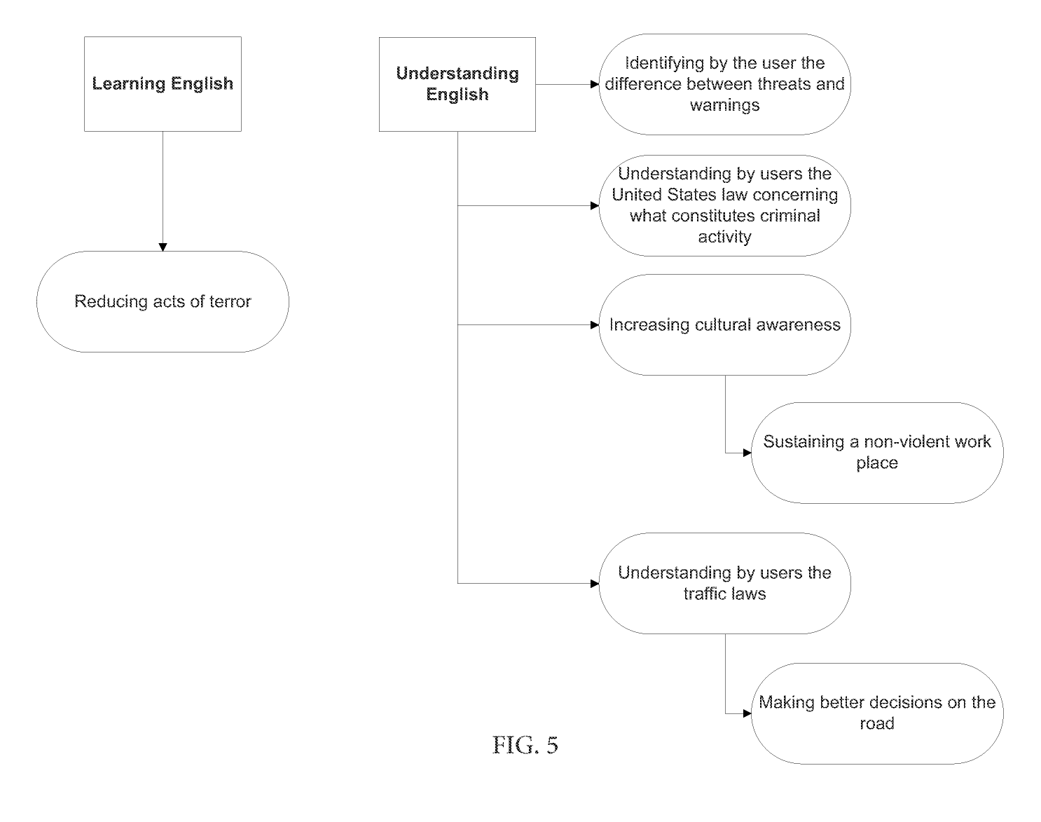

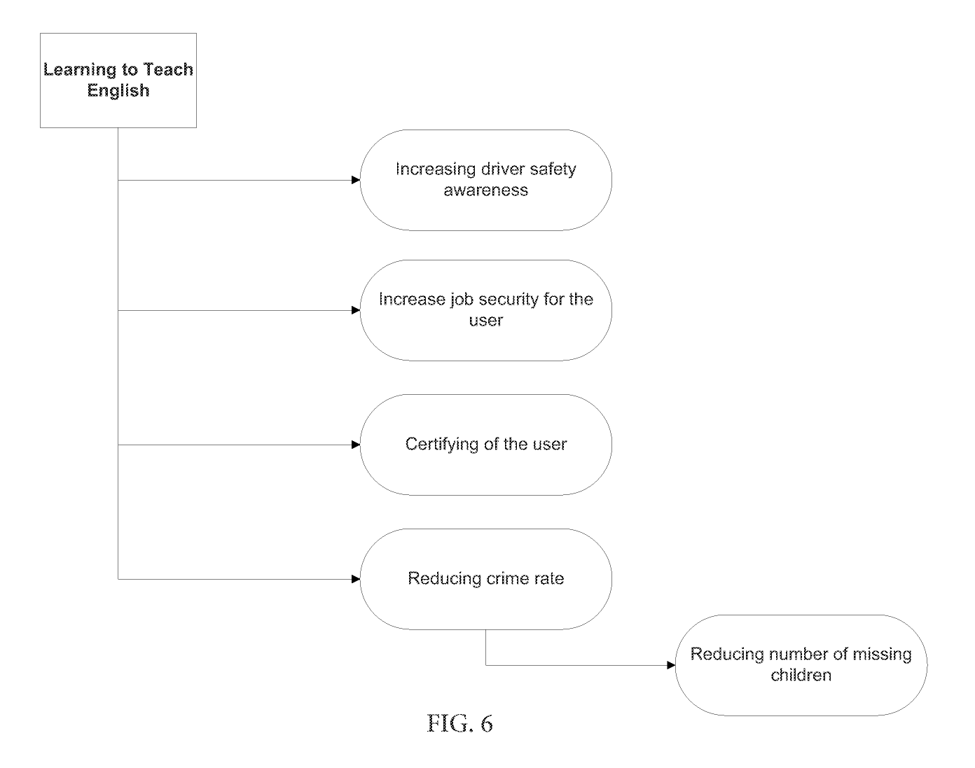

### DETAIL DESCRIPTIONS OF THE INVENTION

All illustrations of the drawings are for the purpose of describing selected versions of the present invention and are not intended to limit the scope of the present invention.

The present invention is a method that allows users learn English while learning to teach English as well. The aim of the present invention is to train children or adults to become teachers of English to speakers of other languages (TESOL). The present invention will teach English to users for a reduced amount of terrorist attacks in the United States, reduced amount of missing children in the United States, increase driver safety awareness in the United States, prepare children to be future educators, increase cultural awareness for employees in the United States, and provide gainful employment to individuals worldwide.

The present invention provides an online system that encourages users to log on for a plurality of purposes including reading, document management, news, learning, and music. The online system is a training center for users that comprises of a home page, an events page, a forums page, a groups page, an account management page, a news page, a polls page, a questions page, a curriculum quiz page, and music page. The online center makes use of a plurality of databases to contain a user's information including a curriculum database, a document database, and a story database. On the home page is the document management interface, where users can access all of their stored documents including homework assignments. Users will be able to access the events page, the forums page, the groups page, the account management page, the news page, the polls page, the question page, the curriculum quiz page, and the music page through the home page. The home page is the portal of the online training center that connects all of the pages together.

The students are encouraged to log onto the online training center everyday to watch curriculum videos from the curriculum database. The curriculum videos will teach students proper English and at the same time teach them to teach others English. Other supplemental methods are available for students to practice their English as well. To forums page allow students of the online training center to use English to discuss a myriad of topics. The topics discussed on the forum can include everyday topics from clothing, electronics, televisions shows, foods, culture, news topics, or games. These online forum discussions will help students develop great writing skills. By using English to discuss different topics, students of different cultures are able to develop a better understanding of not only American culture but other cultures as well. The moderators of the forums will be teachers. Additionally, when students are having trouble with any English topics, they are able to use the forums page to ask questions. The teachers are able to respond by posting responses on the forum thread. If the question to be answered is more personal, students can choose to have their questions be answered privately. However, students can also choose to ask the teachers questions about English publicly. Any other student that may have the same questions can refer to the same forum thread for an answer.

The groups page of the online training center allow students to form and join groups of interest. By forming new groups pages, students are enabled to find common topics of interest with other students to discuss. Students can use the groups page to find other students to use English for discussion of the common interest. These common interest groups can include groups on favorite common foods, favorite singer/band, favorite animal, favorite styles of clothing, favorite video games, or favorite movies. The students will be able to practice and strengthen their English communication and comprehension by discussing a variety of topics with fellow students. Students can link these group pages directly to the forums page for discussion about their topics of interest.

The news page encourages students to read English news articles to practice their English reading and comprehension skills. Students can read news from a variety of different categories including fashion style, sports news, financial news, entertainment news, political news, or general local news. Through reading English news, not only will students strengthen their English reading and comprehension abilities, they will be more informed and understanding about the events occurring around the world. Students who have strong feelings towards certain issues brought up on the news page can refer to the polls page or forums page to voice their opinions. On the forums page, students are able to use English to voice their opinions and debate about certain issues occurring around the world. If students wish to simply know what other students of the online training center think about certain topics, they can create polls on the polls page. The polls pages allow students to contribute their opinions on certain matters anonymously.

The music page allows students of the online training center to listen to music using English lyrics. Music can be a great vehicle for learning English for students who are more musically inclined. Students will be able to listen to music while reading the English lyrics. Through the music and lyrics, students are given the opportunity to understand the lyrics that are being used in the song. The students are able to use the music to understand the context of certain vocabulary used in the lyrics. Through this type of English practice, students are able to gain more understanding of usages of different words and gain a better cultural understanding. Songs chosen to be uploaded onto the music page will include music that uses proper English.

The events page allows students of the online training center to see what events are being held locally that are open to participation. These events allow the students of the program to meet one another and practice interacting using the English language. Students of the online training center can plan event or simply see what events are open to participation directly on the events page.

Students of the online training center will be able to use all of their experiences and knowledge gained from curriculum videos to fully utilize the different pages offered on the online training center. The online training center is an online community that is able to cultivate more English speakers with better cultural awareness. The students can utilize their English lessons from the curriculums to understand and further learn more English vocabulary through music. The students can use their learned skills to discuss or debate issues on news or interests through the forums page. The curriculum videos are also help students to further understand the news articles they are reading on the news page.

For students that are attending public or private schools, the present invention serves as a supplemental which will further enforce what the students learn in their schools. The students will be able to log into the online training center to hear or read different creative stories from life experiences of different teachers stored on the story database. The students will also be encouraged to participate in writing their own stories to share as well. Students will be able to write and upload stories about their own personal experience into a story database of the online training center. By writing their own personal experience story, they will be able to practice and develop their writing skills. Students of the online training center that watch the curriculum videos are also encouraged to participate in the online quizzes through a curriculum quiz page. A plurality of these online quizzes is stored with the curriculum videos in the curriculum database. These online quizzes will test the knowledge that they gain through watching the curriculum videos.

The online training center offers students an account management page to adjust their preferences on the interface as well. They users can change their account passwords and modify their profile information. Additionally, if the user chooses so, he/she may choose to synchronize their accounts with their school system for holding homework documents and other documents.

The present invention is an online training center program that is designed to train the trainer. The program offered by the present invention is offered from pre-kindergarten through 12^{th} grade. Students of the program are encouraged to log on for one hour per week for the duration of the program to view the curriculum videos and complete the online workbooks offered. The online workbooks are stored in the document database of the online training center. The curriculum offered by the present invention is designed to not only teach the English language, but also give the students the needed information to teach the language themselves. At the end of the program, each student will be certified to teach English as a second language.

This interactive online training center is designed mainly to help the United States take control of the acts of terror that is increasing daily. By training children to teach the English language, we can help to eliminate many threats that families are faced with. Learning the English language and then learning how to teach it will help the students understand the difference between threats and warnings. It is only with continued education that will bring peace to families within the United States and keep them away from activities that are determined to be terrorist acts. All countries have different laws concerning what constitutes criminal activity, and it is imperative that the United States has an outlet to voice our laws in an effort to help teach immigrants who are considering visiting, applying to become citizens or even doing business online within the United States.

This interactive online program is also designed to help the United States take control of driver safety. With more and more immigrants moving to the United States, it is vital to teach driver safety to newly certified teachers of English as a second language (TESOL). Although teenagers make up a good percentage of the cause of senseless accidents, immigrants who don't know the laws of the road make up an even larger number. Within the online program, there is a unique curriculum, which focuses on teaching young learners statistic literacy. This curriculum is designed for young learners as a pre-k to 12th grade program, to help give them the needed tools to not only understand statistics but also teach it. They will gain the knowledge to be able to understand why it is important to make better decisions not only on the highways within the United States, but in their everyday lives as well. With better educated citizens, the chances of missing children will decrease due to young learners practicing what they learn within the program. With this new innovative program, students will not only be mentally prepared with the needed skills to teach driver safety, but they will also gain a trade, which will lessen the likelihood of future crimes in our country. It has been proven by statistics that individuals who do not learn a trade, are more likely to commit crimes in order to survive.

With this program, employers would be able to sustain a non violent work place. Young learners would learn the difference between a threat and a warning and would also teach those acceptable and unacceptable behaviors to their students. Today within the United States, more crimes are taking place at the work place due to non-awareness of culture differences. The number of immigrants who decide to become American citizens has been on the rise every year, and with each different background from countries all over the world, learning culture awareness will be vital to limiting the number of violent crimes at the work place in the United States.

This program would also help increase job security, by allowing individuals who are certified or licensed in any given field to teach the risk factors from that particular field to the students. By allowing certified or licensed teachers to teach the risk factors from their certified skills, we can not only increase job security in our own country, but we can gain worldwide unity from teachers abroad. As the number of certified teachers increase, the program will be redesigned to allow new students to become certified to teach English as a second language in multiple fields.

With the curriculum of the present invention in place, American families will begin to feel better about flying in and out of the United States, which will generate more revenue for the United States. This training center was designed as a pre-k through 12th grade program, allowing participants to gain a better understanding of what is considered a terrorist attack early in the program. This will help more immigrants make better decisions when faced with the opportunity to take or kill hostages while they are in the United States. There is a need for the curriculum taught by the present invention, as it will allow immigrants to learn what the United States considers terrorist attacks. Otherwise, the United States citizens will continue to live in fear, which eventually will turn the United States into a third world country that has women and children fearful of someone killing or raping them from a terrorist attack.

This program will help strengthen the students' memories by sharing creative stories as well as provide a database where each child will be able to store their homework assignments from their secondary school they attend within their countries. One reason that students are constantly held back is lack of proof of completed assignments, and our program will provide a document database and document management interface to help them keep track of any and all assignments. With this unique database, students will have assignments that might have otherwise been lost. One major requirement to participate in this program will be that the students must continue their education with the school they are attending within their community regardless of which country they live in. By encouraging the students to continue their education and requiring that they graduate from high school (or its equivalent), in order to receive their certification(s) with our program, we help ensure that our future teachers will be well prepared to not only teach what they have learned, but to also learn new fields.

The present invention will also provide over the phone mentoring to help students deal with their anger to help them focus on their work in school.

Over time, new courses will be offered within the online training center including insurance, real estate, notary public, and other topics. However, the English language will remain the foundation of the basic fundamentals that are taught. By creating a platform which uses the English language as the foundation of its basic fundamentals, we help secure a universal understanding of what constitutes a terrorist act. It is important for all individuals to know what the United States considers terrorists acts now more than ever with the number of Americans conducting business with overseas business owners online.

Although the invention has been explained in relation to its preferred embodiment, it is to be understood that many other possible modifications and variations can be made without departing from the spirit and scope of the invention as hereinafter claimed.

What is claimed is:

1. A method for loss prevention by means of an online training center with a plurality of interface pages including a home page, a events page, a forums page, a groups page, an account management page, a news page, a polls page, a curriculum quiz page, and a music page comprises,
Providing a document management interface by the home page;
Providing a curriculum database;
Providing a document database by the document management interface;
Providing a story database;
Storing of personal experience stories by teachers into the story database;
Storing of curriculum video clips into the curriculum database;
Storing of online quizzes into the curriculum database; and
Storing of homework assignments by the user into the document management database.

2. The method as claimed in claim 1 comprises,
Accessing by a user the events page through the home page;
Accessing by the user the forums page through the home page;
Accessing by the user the groups page through the home page;
Accessing by the user the account management page through the home page;
Accessing by the user the news page through the home page;
Accessing by the user the polls page through the home page;
Accessing by the user the curriculum quiz page through the home page; and
Accessing by the user the music page through the home page.

3. The method as claimed in claim 1 comprises,
Displaying of the curriculum video clips by the online training center;
Learning English by the user through viewing of the curriculum video clips;
Learning to teach English by the user through viewing the curriculum video clips;
Testing the user of curriculum material through online quizzes by accessing the quiz page;
Writing by the user personal experience stories; and
Storing of the personal experience stories onto the story database.

4. The method as claimed in claim 3 comprises,
Reducing acts of terror by learning English;
Identifying by the user the difference between threats and warnings through understanding of English; and
Understanding by users the United States law concerning what constitutes criminal activity through understanding of English.

5. The method as claimed in claim 3 comprises,
Increasing driver safety awareness by learning English;
Understanding by users the traffic laws through understanding English; and
Making better decisions on the road by the users through understanding traffic laws.

6. The method as claimed in claim 4 comprises,
Reducing crime rate by the user learning to teach English; and
Reducing number of missing children by reducing crime.

7. The method as claimed in claim 3 comprises,
Increasing cultural awareness by learning English; and
Sustaining a non-violent work place by the increase of cultural awareness.

8. The method as claimed in claim 3 comprises,
Increase job security for the user by learning to teach English; and
Certifying of the user by learning to teach English.

9. A method for loss prevention by means of an online training center with a plurality of interface pages including a home page, a events page, a forums page, a groups page, an account management page, a news page, a polls page, a curriculum quiz page, and a music page comprises,
Providing a document management interface by the home page;
Providing a curriculum database;
Providing a document database by the document management interface;
Providing a story database;
Storing of personal experience stories by teachers into the story database;
Storing of curriculum video clips into the curriculum database;
Storing of online quizzes into the curriculum database;
Storing of homework assignments by the user into the document management database;
Accessing by the user the forums page through the home page;
Accessing by the user the news page through the home page;
Accessing by the user the curriculum quiz page through the home page;
Displaying of the curriculum video clips by the online training center;
Learning English by the user through viewing of the curriculum video clips; and
Learning to teach English by the user through viewing the curriculum video clips.

10. The method as claimed in claim 9 comprises,
Accessing by a user the events page through the home page;
Accessing by the user the groups page through the home page;
Accessing by the user the account management page through the home page;
Accessing by the user the polls page through the home page; and
Accessing by the user the music page through the home page.

11. The method as claimed in claim 9 comprises,
Testing the user of curriculum material through online quizzes by accessing the quiz page;
Writing by the user personal experience stories; and
Storing of the personal experience stories onto the story database.

12. The method as claimed in claim 11 comprises,
Reducing acts of terror by learning English;
Identifying by the user the difference between threats and warnings through understanding of English;
Understanding by users the United States law concerning what constitutes criminal activity through understanding of English;
Reducing crime rate by the user learning to teach English; and
Reducing number of missing children by reducing crime.

13. The method as claimed in claim 11 comprises,
Increasing driver safety awareness by learning English;
Understanding by users the traffic laws through understanding English; and
Making better decisions on the road by the users through understanding traffic laws.

14. The method as claimed in claim 11 comprises,
Increasing cultural awareness by learning English; and
Sustaining a non-violent work place by the increase of cultural awareness.

15. The method as claimed in claim 11 comprises,
Increase job security for the user by learning to teach English; and
Certifying of the user by learning to teach English.

16. A method for loss prevention by means of an online training center with a plurality of interface pages including a home page, a events page, a forums page, a groups page, an account management page, a news page, a polls page, a curriculum quiz page, and a music page comprises,
Providing a document management interface by the home page;
Providing a curriculum database;
Providing a document database by the document management interface;
Providing a story database;
Storing of personal experience stories by teachers into the story database;
Storing of curriculum video clips into the curriculum database;
Storing of online quizzes into the curriculum database;
Storing of homework assignments by the user into the document management database;
Accessing by a user the events page through the home page;
Accessing by the user the forums page through the home page;
Accessing by the user the groups page through the home page;
Accessing by the user the account management page through the home page;
Accessing by the user the news page through the home page;
Accessing by the user the polls page through the home page;
Accessing by the user the curriculum quiz page through the home page;
Accessing by the user the music page through the home page;
Displaying of the curriculum video clips by the online training center;
Learning English by the user through viewing of the curriculum video clips;
Learning to teach English by the user through viewing the curriculum video clips;
Testing the user of curriculum material through online quizzes by accessing the quiz page;
Writing by the user personal experience stories; and
Storing of the personal experience stories onto the story database.

17. The method as claimed in claim 16 comprises,
Reducing acts of terror by learning English;
Identifying by the user the difference between threats and warnings through understanding of English;
Understanding by users the United States law concerning what constitutes criminal activity through understanding of English;
Reducing crime rate by the user learning to teach English; and
Reducing number of missing children by reducing crime.

18. The method as claimed in claim 16 comprises,
Increasing driver safety awareness by learning English;
Understanding by users the traffic laws through understanding English; and
Making better decisions on the road by the users through understanding traffic laws.

19. The method as claimed in claim 16 comprises,
Increasing cultural awareness by learning English; and
Sustaining a non-violent work place by the increase of cultural awareness.

20. The method as claimed in claim 16 comprises,
Increase job security for the user by learning to teach English; and
Certifying of the user by learning to teach English.
